(19) United States
(12) Patent Application Publication
(10) Pub. No.: US 2012/0191248 A1
(43) Pub. Date: Jul. 26, 2012

(54) Fast-Error/Fast-Exception Handling Scheduler

(75) Inventors: Frederick Page, Morrisville, PA (US); Chris Bohnenberger, Branchville, NJ (US); Roy Barr, Delaware, NJ (US); Yue Pei, Edison, NJ (US)

(73) Assignee: Siemens Healthcare Diagnostics Inc., Tarrytown, NY (US)

(21) Appl. No.: 13/003,350

(22) PCT Filed: Jul. 9, 2009
(86) PCT No.: PCT/US09/50088

§ 371 Date: Feb. 23, 2012

Related U.S. Application Data
(60) Provisional application No. 61/079,447, filed on Jul. 10, 2008.

(51) Int. Cl. G05B 13/02

(52) U.S. Cl. 700/266

(57) ABSTRACT

A method of scheduling an operation and a method of salvaging a launched test on a sample analyzer having a plurality of system resources for which there is a discrete, redundant subsystem Methods include scheduling real-time actions for execution on the subsystem or its redundant subsystem, linking the subsystem or a first redundant subsystem to another subsystem or to a second redundant subsystem, commanding the subsystem or the redundant subsystem to execute the actions for execution, executing each of the actions, monitoring execution of the actions, and re-scheduling an action for execution on a first subsystem on a corresponding discrete, redundant subsystem when an error or malfunction has occurred that may impact the launched test If re-scheduling is not possible, then the method includes trying to pause the launched test When pausing fails, the method includes marking the test bad an removing the test with minimal interference.

### CROSS REFERENCE TO RELATED APPLICATIONS

The present utility patent application claims the benefit of priority through U.S. Provisional Patent Application No. 61/079,447 dated Jul. 10, 2008 entitled “Error-Handling Scheduler”.

### STATEMENT REGARDING FEDERALLY SPONSORED RESEARCH OR DEVELOPMENT

(Not applicable)

### BACKGROUND OF THE INVENTION

The present invention relates to system analyzers and control systems therefor, and, more specifically, to a scheduler and control system for providing fast-error handling and fast-exception handling to a system analyzer having at least one redundant subsystem.

Providing multiple, redundant subsystems to system analyzers such as chemo-luminescent analyzers is not commonly practiced due to the added size and cost of the subsystems. However, multiple, redundant subsystems provide a limited ability to continue to process samples in the event that one of the subsystems becomes inoperable. Indeed, when multiple redundant subsystems are provided, the redundant subsystems are interchangeable. As a result, after a test sample has been launched, a redundant subsystem can operate in the place of a corresponding subsystem in the event that the corresponding subsystem is rendered inoperable.

Salvaging test samples that have been launched without adversely affecting throughput is particularly desirable. Accordingly, it would be desirable to provide a scheduler for salvaging test samples and, further, for actually increasing throughput despite the inoperability of a subsystem for which there is a redundant subsystem. More specifically, it would be desirable to provide a fast error-handler and/or fast exception handler and related error- and/or exception-handling applications, software, and the like, to limit the impact of unexpected events.

### SUMMARY OF THE INVENTION

A method of scheduling an operation on an object and a method of salvaging a launched test on a sample analyzer having a plurality of system resources, at least one of which having a discrete, redundant subsystem, is disclosed. The method includes scheduling in real-time a plurality of actions for execution on the subsystems; linking at least one subsystem or a first discrete, redundant subsystem to another subsystem or to a second discrete, redundant subsystem; commanding the subsystems and the discrete, redundant subsystem to execute the actions; executing each of the actions; monitoring execution of each of the actions; and re-scheduling or delaying (“pausing”) or marking a launched test “bad” in the event that there is a deviation, e.g., an error of malfunction, from the normal flow of a launched test.

Also disclosed is a scheduler for a sample analyzer having at least one redundant subsystem. The scheduler includes a scheduling device that is structured and arranged to schedule, unschedule or reschedule at least one action to be executed by a subsystem. More specifically, the scheduling device is structured and arranged to execute a desired function on an object by scheduling the desired function on an appropriate subsystem and to complete the desired function, if necessary, by marking the launched test bad; by “pausing” the launched test; and/or by rescheduling the desired function on a corresponding appropriate subsystem whenever execution of the desired function experiences a deviation from normal flow, e.g., an error or a malfunction on the appropriate subsystem.

Finally, a sample analyzer is disclosed that includes a plurality of system resources for performing discrete operations; at least one discrete, redundant subsystem; a scheduler; an action assembly builder that is structured and arranged to link a first scheduled action to a second scheduled action; and a controller that is structured and arranged to generate a first set of command signals to execute a desired function on an object on an appropriate subsystem. Whenever possible, the scheduler and controller are further adapted to salvage the object, e.g., a launched test, in the event of an error or malfunction on the sample analyzer by completing the desired function on a corresponding, redundant subsystem; by “pausing” the launched test or, when re-scheduling and pausing fail, by marking the launched test bad and removing it from the system analyzer.

### BRIEF DESCRIPTION OF THE DRAWINGS

The invention will be more fully understood by referring to the Detailed Description of the Invention in conjunction with the Drawings, of which:

FIG. 1 shows a block diagram of an embodiment of subsystems for a system analyzer in accordance with the present invention;

FIG. 2 shows a block diagram of the instrument controller for a system analyzer in accordance with the present invention;

FIG. 3 shows a scheduler schedule with a present time line;

FIG. 4 shows the scheduler schedule from FIG. 3 after the present time line has intersected two action blocks; and

FIG. 5 shows the scheduler schedule from FIG. 4 after the present time line has passed through one of the action blocks and has intersected two new action blocks.

### DETAILED DESCRIPTION

A high-level scheduler for use with a sample analyzer, e.g., a chemo-luminescent analyzer, having multiple redundant subsystems is disclosed. The scheduler is adapted to provide fast-error handling and fast-exception handling functions, to improve throughput. The scheduler utilizes the presence and availability of multiple redundant subsystems to salvage as many launched tests of samples as possible in the event of any deviation from normal flow. For example, a deviation can include an error with or malfunction of a redundant subsystem and/or its control software and/or a cancellation of the launched test. Hence, the scheduler is designed to schedule tests, primes, dilutions, racks of samples, derelict reaction tubes, and so forth in a subsystem-by-subsystem manner.

Advantageously, the present scheduler approach enables users to schedule subsystems and resources to complete pre-specified assay protocols as expeditiously as possible prior to launching of the test itself, without directly conflicting with any launched tests. For example, the scheduler can set up dilutions; fill vessels with a discrete reagent or with a plurality of reagents; move racks and/or wedges that contain filled or empty vessels to a desired location; and the like.

A fast-error handling capability and a fast-exception handling capability account for unexpected events, i.e., deviations, that may result from the cancellation of a launched test or from a mechanical, software or other error/malfunction in one of the redundant subsystems. The objects of the fast-error handling capability and a fast-exception handling capability are to prevent a launched test from being classified as “bad” when possible. Indeed, using redundant subsystems interchangeably to complete and save a launched test that would otherwise be classified as “bad” is novel in the art and is a desirable quality of the present invention.

In the abstract, a scheduler is a set of interfaces into and within a schedule but also refers to the hard-wired device, software for controlling the device, computer-executable code for the software, and the like that interfaces with or enables an interface with the schedule. A scheduler contains a multiplicity of software interface classes for manipulating the schedule.

Interface classes are adapted to manipulate or modify the schedule by, for example, adding an action to or removing an action from the schedule; and to set up, change, and/or remove an object, e.g., a rack, a test, an event, and the like, that contains or may contain a set of pointers into the schedule.

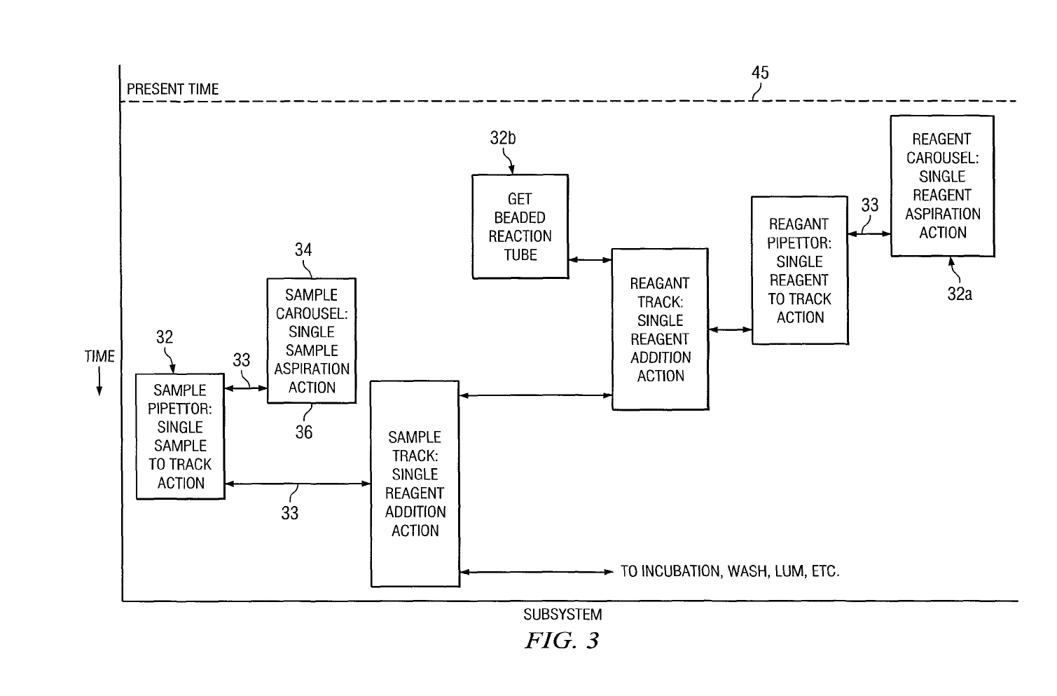

A schedule, which is represented conceptually in FIG. 3 as a pegboard, is a two-dimensional array of actions for one or more subsystems of a sample analyzer to execute in a logical and a chronological order to perform a desired task or operation. The pegboard, then, is the central structure for holding present and future activities of the system analyzer. The scheduler creates and maintains the pegboard.

The schedule is a conceptualized table of subsystems or resources versus time. The scheduler is adapted to execute wholly unrelated operations, e.g., rack removal, reaction tube removal, reagent aspiration, reagent dispensation, and so forth, without any one operation impeding any other operation. Necessarily, the schedule itself is detached from operation, which means that it has no real-time requirements.

As shown in FIG. 3, schedule time is unbounded in the y-direction and each “scheduled” entry on the schedule constitutes a single action. Actions correspond to the smallest schedulable unit, which is also commonly referred to as an atomic unit. The atomic units of behavior are stored in the scheduler. An action can include without limitation one or more of the following: identification of the action, start time of the action, identification of the subsystem performing the action, end time of the action, priority of the action, whether or not the action has been committed, and so forth.

Each action also includes a status, such as “scheduled”, “not scheduled”, “in progress”, and “completed”. A “scheduled” action refers to an action that is included for execution in the two-dimensional array, which is to say, any action that is included on the conceptual schedule. An “unscheduled” action is one that is available for use by the scheduler, but that has not been included on the schedule. The other two statuses are self-explanatory and mentioned below.

Plural actions can be assembled or collected to denote that they are interrelated or interdependent. An action assembly or action assembly builder, which can be an integral part of the scheduler or a separate stand-alone device, interrelates the collected actions. The action assembly builder converts a requested high-level activity, e.g., a patient test, into an action assembly. The primary purpose of the action assembly builder portion is to establish temporal relationships between actions such that they are made available to the scheduler. Indeed, the quicker that the scheduler can schedule actions—especially in the event of an error or malfunction of a subsystem—the greater the throughput of the analyzer.

A secondary purpose of a scheduler is to track and provide interfaces for occupancy of subsystems that require the same. Occupancy refers to the number of removable schedulable events, e.g., the number of positions for racks or reaction tubes in or on the subsystem.

As previously mentioned, for the purpose of this disclosure, a scheduler can refer to a hardware, a middleware, and/or a software application that can create, schedule, and execute an action(s) in real-time. Examples of a hardware application can include, for the purpose of illustration and not limitation, a processor, a microprocessor, a personal computer, a controller, a control system, and so forth. Software applications can include the machine-executable code for a driver program, an application, an algorithm, and the like and/or the tangible object on or in which the machine-executable code is stored.

### Scheduler Optimization

The scheduler is structured and arranged to schedule jobs or tests (both launched and yet-to-be launched), racks, primes, dilutions, derelict reaction tubes, and the like, to complete pre-established assay protocols on a sample with a high level of rack throughput. Inherent in the scheduler is the ability to schedule operations on a subsystem-by-subsystem basis, substituting redundant subsystems, when and as necessary, and, more particularly, to salvage launched tests to the extent possible.

According to the present invention, the following optimization function enables one to determine which tests to launch and which resources, e.g., reagent, bead, sample, baffles, and the like, to use:

Jm|nwt,prec,rⱼ,res_{baffle}12722,res_{reagent} . . . k,res_{bead} . . . 1,resₛₐₘₚₗₑ . . . 1z,res_{reaction tube} 1 . . . 2|10⁵C_{Pmax}+C_{Rmax}

in which:
J or j refers to a job;
Jm refers to a job shop, in which each job has a discrete, pre-determined path;
nwt refers to “no wait”, whereby jobs are not allowed to wait between two successive subsystems;
prec refers to precedence constraints, whereby some jobs must be completed prior to other jobs;
rⱼ refers to release dates, corresponding to the earliest specified time that a job may begin processing or the time a job arrives at a subsystem;
res Λσρ refers to resource constraints (Λ=number of types, σ=limit per type, and ρ=maximum requirement for a task);
k refers to the maximum amount of reagent;
z refers to the maximum amount of sample;
C_{Pmax} refers to the amount of time between the start and finish of a sequence of jobs and/or tasks, i.e., the “makespan”, of all tests that are released within a priority class multiplied by their priority; and
C_{Rmax} refers to the makespan for all tests from a particular rack.

Moreover, the following optimization functions represent portions of the scheduler to perform discrete tests with the highest level of throughput:

Choice of a Bead Pack within a Carousel:

1|res . . . 1,rⱼ,Dⱼ|Lₘₐₓ

where Dⱼ refers to a deadline for job j, and Lₘₐₓ refers to a maximum completion time or due time.

### Choice of Incubators:

Pmt|nwt,rⱼ|today's precedence.

Choice of a Reagent Wedge within a Carousel:

1|res . . . 9,rⱼ,Dⱼ|Lₘₐₓ;

### Choice of a Kit:

1|res . . . 1,rⱼ,Dⱼ|Lₘₐₓ;

### Sample Pipettors:

Pm|nwt,rⱼ,resₛₐₘₚₗₑ11z|today's precedence;

### Reagent Pipettors:

Pm|nwt,rⱼ,res_{reagent} . . . k|today's precedence.

“Today's precedence” in connection with the incubators and pipettors refers to a means whereby the wear on each of the redundant incubators/pipettors is leveled so that one incubator/pipettor is not used more frequently—and, hence, would be subject to great wear—than another of the redundant incubators/pipettors. Hence, “today's precedence” would correspond to a 1-2-3, or a 2-3-1 or a 3-1-2 order of precedence in which each of the numbers refers to a discrete incubator/pipettor.

### Control Architecture

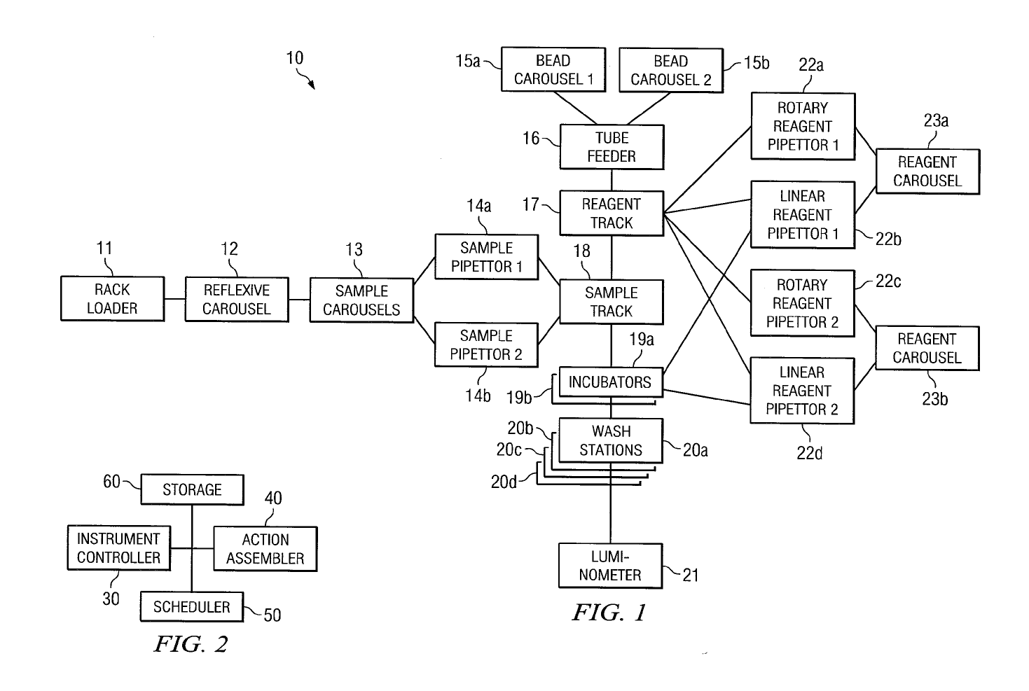

Illustrative control side architecture and inter-subsystem interfaces for a system analyzer are shown in FIG. 1. The number and function of the various subsystems are for illustrative purposes only, for the purpose of describing the function of the scheduler. All of the subsystems in FIG. 1 are well-known to those skilled in the pertinent art and, consequently, their function and interrelationship will not be described in detail.

The embodied system analyzer 10 includes a rack loader 11, a reflexive carousel 12, a sample carousel 13, redundant sample pipettors 14a and 14b, redundant bead carousels 15a and 15b, a reaction tube supply feeder 16, a reagent track 17, a sample tube track 18, redundant sample incubators 19a and 19b, redundant wash stations 20a and 20b, a luminometer 21, redundant reagent pipettors 22a-22d, and plural reagent carousels 23a and 23b. For illustrative purposes only, the number of sample pipettor 14a and 14b, bead carousel 15a and 15b, reagent carousel 23a and 23b, and incubators 19a and 19b wash station redundancies 20a and 20b are each two. More incubators and/or more or fewer sample pipettors, bead carousels, reagent carousels, and/or wash stations could be included. The presence and availability of multiple discrete, redundant subsystems makes the present scheduler desirable.

As shown in FIG. 1, each of the redundant sample pipettors 14a and 14b is operatively connected to the sample carousel 13 and to the sample tube track 18 so that a test sample or diluent contained in a vessel disposed in the sample carousel 13 can be aspirated and dispensed by one of the sample pipettors 14a or 14b and dispensed into a vessel that is disposed in the sample tube track 18. A first plurality of reagent pipettors 22a and 22b is operatively connected to one of the plural reagent carousels 23a and a second plurality of reagent pipettors 22c and 22d is operative coupled to another of the plural reagent carousels 23b. Each of the redundant reagent pipettors 22a-22d is operatively connected to the reagent track 17 while at least one of the first 22b and at least one of the second pluralities of reagent pipettors 22d are operatively connected to one or more of the redundant incubators 19a and 19b. The reagent carousels 23a and 23b and reagent pipettors 22a-22d, are operatively connected so that a desired amount of a reagent can be aspirated from a vessel disposed in one of the redundant reagent carousels 23a or 23b.

One or more of the redundant reagent pipettors 22a-22d is operatively connected to the reagent track 17 and to the redundant incubators 19a and 19b so that the aspirated reagent can be dispensed into a vessel that is disposed in the reagent track 17 or, alternatively, that is disposed in either of the redundant incubators 19a and 19b.

FIG. 1 shows that the redundant reagent pipettors 22a-22d include rotary pipettors 22a and 22c, which are operatively connected to the reagent track 17, and linear pipettors 22b and 22d, which are operatively connected to the reagent track 17 and to one or more of the redundant incubators 19a and 19b. The selection of rotary or linear pipettors is arbitrary. However, as previously mentioned, to level the collective wear of the redundant reagent pipettors 22a-22d the order of use can be controlled.

Referring to FIG. 2, the analyzer system 10 further includes an instrument controller 30, an action assembly builder 40, the scheduler 50, and data storage 60. Although these system elements are described and referred to as separate functions or distinct devices, all or any combination of the system elements could also be implemented as portions of the scheduler 50 or of a master controller.

The instrument controller 30 is structured and arranged to determine which commands to send to which system resources and to determine when to send the commands. For this purpose, the controller 30 uses the schedule. The controller 30 further receives replies from subsystems; analyzes the replies; and utilizes the replies to determine whether or not the operation succeeded or failed. Depending on success of failure, the controller 30 handles the further disposition of the launched test.

The instrument controller 30 can be implemented using a processor, microprocessor, personal computer, and the like, having an input/output interface(s) and adequate memory, e.g., volatile random access memory (RAM) and non-volatile read-only memory (ROM). The controller ROM, which could include all or some portion of the data storage 60, can include software or hardware that includes applications, algorithms, driver programs, and the like for operating the scheduler 50, the action assembly builder 40, and the various subsystems shown in FIG. 1. The program executed on the controller's RAM is adapted to selectively call and execute any called driver programs, application, algorithm, and the like stored in the controller ROM.

### Action Assembly Builder and Scheduler

Scheduling of an atomic behavior or a multiplicity of atomic behaviors using the schedule in a time-sensitive manner is performed by the scheduler 50. However, the scheduler 50 uses the action assembly builder 40 to convert a requested high-level activity into an action assembly. As previously mentioned, the scheduler 50 maintains the means for holding present and future activities, i.e., the schedule.

Identifying a discrete subsystem to execute the atomic behavior in a time-insensitive manner and interrelating plural “scheduled” actions are performed by the action assembly builder 40. The atomic unit of the action assembly builder 40 is the action itself. Hence, before the function of an action assembly builder 40 can be described, one must better understand what is meant by an action.

In the abstract, an “action” refers to the atomic behavior that is supported by a discrete subsystem. More concretely, however, an action also contains information about the atomic behavior of each subsystem that is of interest or can be useful to the scheduler 50 and the scheduling function. For example, for the atomic behavior associated with aspirating a reagent, the created action must address the portion of the action, i.e., the job or task, that relates to a particular reagent stored in a particular reagent bottle on one of the reagent carousels 23a or 23b as well as one of the reagent pipettors 22a-22d.

Atomic behavior can include an action “state”, for example, “not scheduled”, “scheduled”, “dispatched”, and “completed”. “Not scheduled” refers to an action that has been created but that has not been integrated into the schedule (by the scheduler 50 as described below). “Scheduled” refers to an action that has been created and that has been integrated into the schedule by the scheduler 50. Scheduled action can be “reserved” or “committed”, which also is described below. “Dispatched” refers to an action command(s) that has been sent to a subsystem(s) but for which no reply has been received. “Completed” connotes that the action command(s) has been received by the particular subsystem(s), which has acknowledged receipt of the dispatched action, and that the reply signal from the particular subsystem has been processed.

An action models the maximum amount of time required to complete an atomic behavior and/or an action models the timing relationship between interrelated actions of different subsystems. The former allows the scheduler 50 to schedule atomic behavior(s) without over-scheduling a discrete subsystem so as to require two actions to be completed by the same subsystem concurrently. With the latter, information or packets about interrelated actions can be assembled beforehand awaiting an appropriate launch time to carry them out.

A primary purpose, then, of the action assembly builder 40 is to describe each test or job for one or more subsystem in an absolutely time-insensitive manner. The action assembly builder 40 is concerned not so much with the number of subsystem redundancies or with the launch time of an assembled action but, rather, with which discrete subsystem(s) is operational to execute the action behavior and with the relative temporal relationship between plural interrelated actions. The assembly builder 40 constructs assembled actions of arbitrary complexity without assigning a launch or start time of the action assemblies. The scheduler 50 assigns the launch or start time of the action assemblies and assigns subsystems and resources. Such information allows assembling actions of arbitrary complexity in advance of the actual launch time. This will become more apparent in the discussion below about the schedule.

More specifically, the action assembly builder 40 assembles plural actions by discrete subsystems, e.g., using calls, and further describes how the actions relate to one another and how the actions are constrained by one another. For example, in order to transfer a tube containing reagent from the reagent track 17 to the sample track 18, it is known in advance that at least two interrelated tasks are involved. Hence, it is efficient and makes good sense to assemble the various individual tasks in a single, executable action in advance of the actual launch time of that action.

Returning to the example, a first task involves a reagent track transferring action to transfer a discrete sample tube containing a reagent from a discrete location in the reagent track 17. The subsystems involved include, inter alia, the reagent track 17 and a transferring device (not shown). The second task involves a sample track receiving action to receive a discrete sample tube at a discrete location in the sample track 18. The subsystems involved include, inter alia, the transferring device (not shown) and the sample track 18. The action assembly builder 40 then can prepare in advance of the actual launch time a call to a single action that, when “scheduled” on the schedule, will generate the necessary action commands to the necessary subsystems to execute the action behavior.

The action assembly builder 40 and its interrelationship with the scheduler 50 will now be described again using a schedule concept (FIG. 3). As previously mentioned the functionalities of the action assembly builder 40 and scheduler 50 can be fragmented in a different arrangement from the one chosen and described herein.

Conceptually, it is known in advance that the atomic behavior of any action will consume time and/or system resources. The time element is measured between a launch or start time and an end time. On the schedule, time is a continuum in the y-direction. System resources can refer to subsystem capabilities, kit components, discrete subsystems, redundant subsystems, consumables, e.g., sample tubes, disposable tips, tube covers, cuvettes, reagents, wash solution, and so forth.

For every system or consumable resource needed to complete some task that is a portion of an atomic behavior, the scheduler 50 must first determine that system or consumable resource is available before the action is included in the schedule. Consequently, whenever the scheduler 50 includes an action in a schedule (the “pegboard”), an “OnSchedule” operation associated with the respective action and/or the controller 30 will automatically allocate and reserve, i.e., set aside, the required system and consumable resources, to complete the tasks and the action when (and if) that action is actually launched and when (and if) the task is commenced during the action.

Consumable resources have an actual or physical existence, e.g., a volume of reagent in a reagent bottle or a number of test tubes in a test tube rack, as well as a virtual existence, e.g., as data in a database. For example, data files on reserved consumable resources and data files on total available consumable resources can be maintained in memory, e.g., in a Datastore database 60.

Datastore 60 is a common repository for information having to do with the system analyzer, such as the current state and/or capabilities of each subsystem, and consumable resources, such as the contents of each carousel and each incubator and so forth, for use thereon.

Hence, when an “OnSchedule” operation for a discrete action or action assembly is called, the appropriate total available resources data files associated with the action/action assembly are debited and appropriate reserved resources data files that are unique to the subsystem or, alternatively, to the discrete action/action assembly are credited with the amount of resources debited from the total available resources data files. Advantageously, the controller 30, action assembly builder 40, and scheduler 50 are adapted so that the reserved consumable resources do not exceed the total available resources. When this would otherwise occur, the controller 30 is adapted to prepare a warning signal to alert the user that the system analyzer needs more of the resource. Moreover, the scheduler 50 is adapted not to schedule an action/action assembly for which system or consumable resources are wanting.

FIGS. 3-5 show various stages of a conceptual schedule. The ordinate (y-axis) indicates the progression of time, which is a continuum. Plural non-specific “scheduled” actions boxes are disposed along the abscissa (x-axis), which is dimensionless. A present time line 45 provides indicia of real time. Hence, values along the ordinate below the present time line 45 are representative of future, approaching time.

Each action box 32 refers to an action to be completed rather than to the particular subsystem that is to complete the action. Any action box 32 shown on the schedule is in a “scheduled” state for which system and consumable resources have been reserved. Actions that are not included on the schedule remain in an “unscheduled” state.

The “height” dimension in the y-direction of each action box 32 is time-sensitive, indicating (at the top portion 34) the time the action was launched or is scheduled to be launched and (at the bottom portion 36) when the action is scheduled to be and should be completed. In short, the “height” dimension of the action box 32 is representative of the amount of time required between starting and completing a particular action.

It should be noted, however, that a single action may require one or more subsystems to complete. Each subsystem completing a task or job that makes up the action. For example, the sample pipettor action box 32 (FIG. 3) involves dispensing a previously-aspirated test sample, which is contained in one of the redundant sample pipettors 14a or 14b, into an empty reaction vessel disposed in the sample track 18. Accordingly, when the action is completed, one of the sample pipettor 14a or 14b and the sample track 18 subsystems have been used. A single action covers each task.

The arrows in FIGS. 3-5 illustrate links or link points 33 between inter-related, assembled actions 32. Link points 33 connote that the linked action boxes 32 are interdependent, which is to say that each linked action 32 depends on the other linked action 32 in order for each to be completed. In most instances, the linked actions imply that the assembled actions share a common subsystem.

Link points 33 are generated by the action assembly builder 40. Hence, linked action boxes 32 indicate an “action assembly”, which further designates that certain potentially-limiting, timing requirements are imposed between the linked actions assemblies. For example, the temporal location of the links 33 along the “height” of the subsystem action box 32 indicates the earliest or the necessary starting time of communication between the sending and the receiving linked subsystems in the subsystem sequence. This will be further explained by the example below.

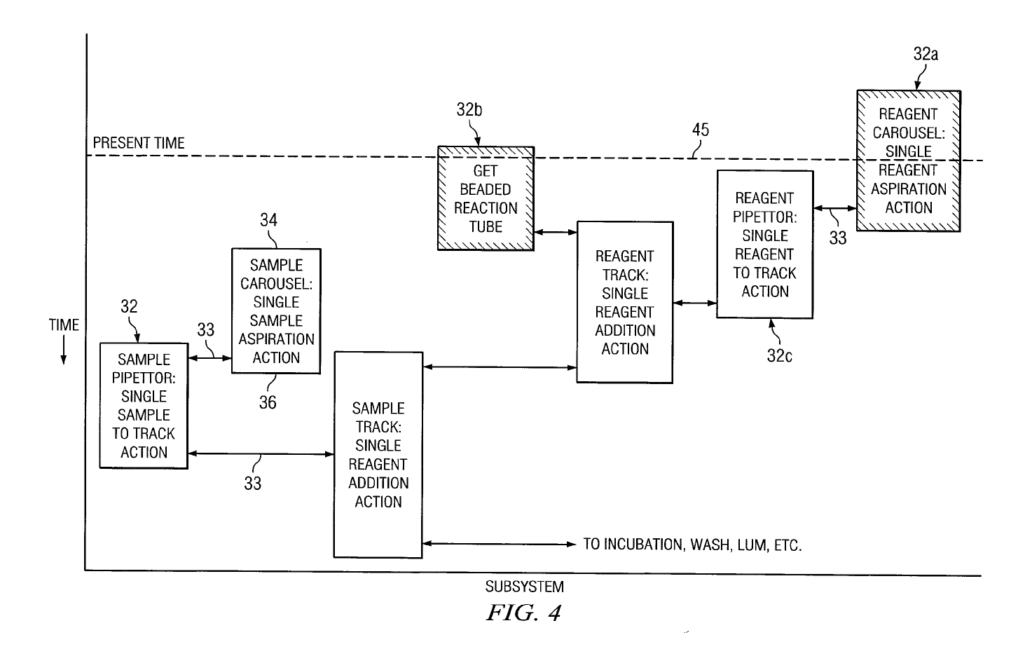

The schedules include a moving, present time line 45 that moves towards values of future time, which is to say toward the abscissa axis. In FIG. 3, the present time line 45 has not intersected any of the scheduled action boxes 32 so there are no actions being executed. In FIG. 4, the present time line 45 is shown having intersected the top portions 34 of two scheduled action boxes 32a and 32b. Although the two scheduled action boxes 32a and 32b are not directly linked to each other, the dependence of the scheduled actions is shown.

The first action box 32a corresponds to a single reagent aspiration action, involving, for example, one of the reagent pipettor 22a-22d subsystems and one of the reagent containers stored in one of the reagent carousel 23a or 23b subsystems. The second action box 32b corresponds to an acquire beaded reaction tube action, involving, for example, one of the beaded reaction tube carousels 15a or 15b subsystems and the tube feeder 16 subsystem.

When the present time line 45 first intersects the top portion 34, i.e., the launch time, of the first scheduled action box 32a, the controller 30 automatically constructs or the action itself constructs an appropriate action command(s) corresponding to the first action box 32a, i.e., perform single reagent aspiration, and subsequently dispatches the command(s) to the corresponding available subsystem(s), e.g., an appropriate reagent carousel 23a or 23b and an available reagent pipettors 22a-22d. Once the action command(s) has been sent, the state of the atomic behavior of the action changes from “scheduled” to “dispatched”.

Chronologically, as time progresses (increases) such that the present time line 45 intersects the top portion 34, i.e., the launch time, of the second scheduled action box 32b, the controller 30 automatically constructs or the action itself constructs an appropriate action command(s) corresponding to the second action box 32b, i.e., get beaded reaction tube, and subsequently dispatches the command(s) to the appropriate, corresponding subsystem(s), e.g., an appropriate bead carousel 15a or 15b and the tube feeder 16. Once the appropriate action command(s) has been sent, the state of the atomic behavior of the action changes from “scheduled” to “dispatched”.

After a subsystem has received a dispatched action command, the subsystem is adapted to prepare and to transmit a response message or signal to the controller 30 or to the action itself, indicating that the dispatched action command has been received. The acknowledgement reply message or signal must be received by the controller 30 and/or the action before expiry of the maximum allowable duration of the action, which is to say, before the present time line 45 intersects the bottom portion 36 of the action box 32. This is to provide time to execute the next activity associated with the particular subsystem so as not to delay the next activity. Cumulative lateness results if an acknowledgement reply message or signal is not received before expiry of the maximum allowable duration of the action.

The message or signal in response to receipt of the dispatched action command can also include a subsystem status message, informing the controller 30 or action that the subsystem is or is not functioning and is or is not capable of executing the designated action. Alternatively, a message or a signal, which is separate from the acknowledgement reply signal, informing the controller 30 or action that the subsystem is or is not functioning and is or is not capable of executing the designated action, can be transmitted. The advantage of providing a subsystem status message informing the controller 30 or the action of the working status of the subsystem provides more reaction time to re-route or re-schedule launched tests before cumulative lateness begins by using redundant subsystems.

It is important if not crucial that each subsystem acknowledges receipt of the action command(s) before the present time line 45 reaches or passes the bottom portion 36 of the corresponding action box 32 or, if linked, before the present time line 45 reaches or passes the link point 33. Indeed, time is needed to execute the next action so as not to delay the commencement (and/or completion) of the next action. Were this to happen, cumulative lateness will result with respect to the subsystem involved.

Alternatively, instead of a subsystem automatically providing a message or signal confirming its operability status to the controller 30 or action, contemporaneous with or prior to dispatching an action command(s) to an appropriate subsystem(s), the controller 30 or the action itself also checks the corresponding subsystem(s) to ascertain whether or not the subsystem(s) is/are still capable of executing the tasks corresponding to the action command(s). This information is automatically provided to the scheduler 50.

Contemporaneous with or prior to dispatching an action command(s) to an appropriate subsystem(s), the controller 30 or the action itself also checks to ensure that consumable resources needed to complete the action or a task portion of the action are available in one of the appropriate subsystems and/or have been previously reserved.

Once the corresponding action has been completed by a subsystem, the subsystem prepares and sends a completion signal to the controller 30 or action. This changes the state of the action behavior from “dispatched” to “completed”.

When an error or malfunction occurs that may affect a launched test, the subsystem experiencing the interruption can be adapted to transmit an error message to the controller 30, to alert the controller 30 of the interruption, error or malfunction and/or the controller 30 can continuously monitor the activity of each subsystem to ensure that the subsystem executes the action to completion. Error-handling and exception-handling are described in greater detail below.

Once a subsystem signals the controller 30 or action that the command has been carried out, the controller 30 or action is adapted to call and execute an “OnReply” function. The “OnReply” function is adapted to extract from the reply message data on the success of the action, on any changed conditions or capabilities in connection with the subsystem(s), and so forth. Data of changed conditions or capabilities with each subsystem can be stored for the purpose of providing resource updates as well as for providing necessary alerts or warning messages that a particular subsystem needs some attention.

When an atomic behavior is canceled or otherwise stopped prior to completion (or commencement) of the action by an appropriate subsystem, the system resources and the reserved consumable resources that have not been consumed at the time of interruption or cancellation are freed up by the scheduler 50 using an “OnUnschedule” operation. For example, as part of an “OnUnschedule” operation, a “scheduled” action box 32 is removed from the schedule, and placed in an “unscheduled”, i.e., available, action state. The remaining consumable resources not consumed are credited to the actual resource database for use in another action.

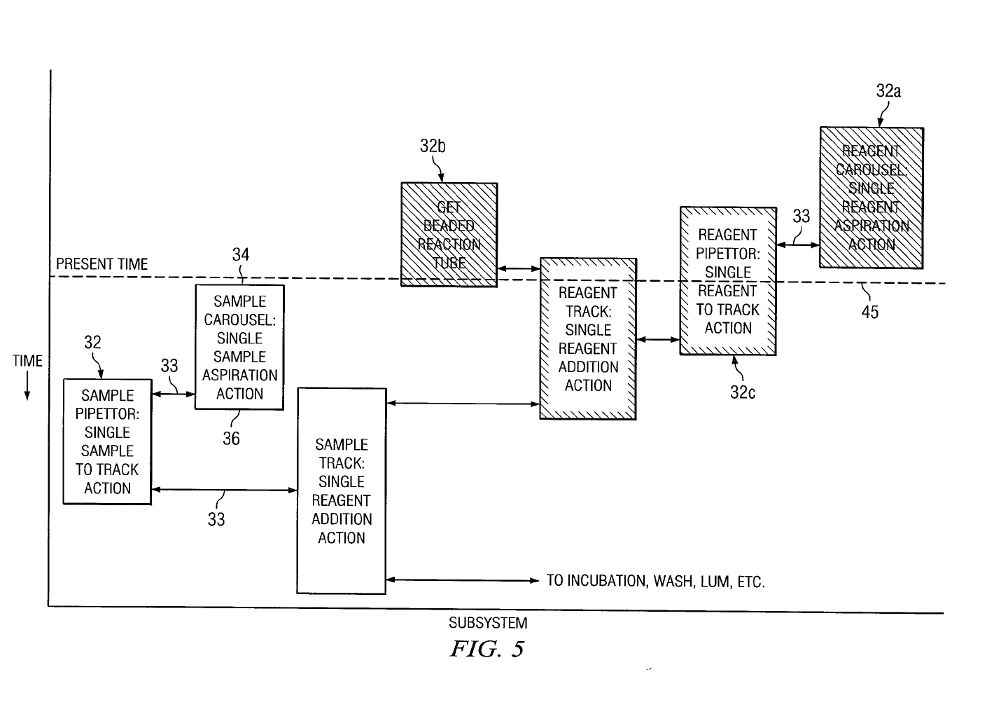

Referring to FIG. 5, with additional time, the present time line 45 will intersect the link point 33 between the first, scheduled action box 32a and a third, scheduled action box 32c. Action box 32a and action box 32c constitute an “action assembly”, which is evident on the schedule from the link point 33 between the two. The third, scheduled action box 32c corresponds to a single reagent dispensing action, involving one of the reagent pipettors 22a-22d subsystems and the reagent track 17 subsystem. Here again, the location of the link point 33 indicates the real time at which communication between the linked actions 32a and 32c should be established in order to stay on schedule.

The particular link point 33 between the first and third scheduled action boxes 32a and 32c delineates that whichever of the reagent pipettor 22a-22d subsystems—which is the subsystem common to both actions—is used for the first, scheduled action 32a will also be used in the third, scheduled action 32c. More particularly, the reagent volume aspirated according to the first, scheduled action 32a will be dispensed during the third, scheduled action 32c.

### Fast-Error Handling and Fast-Exception Handling

Fast-error handling and fast-exception handling are desirable qualities of the present system. Indeed, once an action is launched, from a scheduling and scheduler point of view, there is, essentially, only success or failure. Thus, the ability of the system to re-allocate resources, e.g., redundant system resources, to salvage launched tests that would otherwise have to be removed and re-started or to handle a high priority, stat test that may require bumping a launched test temporarily, provides a significant savings in time, money, and sample through improved throughput.

Accordingly, for fast-error handling, the controller 30, action assembly builder 40, and scheduler 50 are structured and arranged to respond to any error, malfunction or other indicia of non-completion of a launched test by, in order of preference: re-scheduling the action involved, “pausing” the test or marking the test “bad”. The preferred or desired outcome is re-scheduling the action. Rescheduling may include changing the subsystem using any available “unscheduled” actions that are associated with an appropriate, redundant subsystem similar to the interrupted subsystem and/or changing the consumable resource. In this manner, the launched test can be salvaged by re-locating it from the interrupted subsystem to the corresponding, appropriate, redundant subsystem for completion of the action and subsequent disposition. Disadvantageously, all actions that have been launched or rely on actions that have been launched are fixed in that they occupy a fixed space in time on the schedule.

If re-scheduling is not possible but the scheduler 50 is able to formulate an alternative path—or even use the original path—before the system resource or consumable resource is actually needed, then “pausing” the test is the next most desirable outcome. A test that is “paused” may or may not be completed. The launched test remains unchanged until either the reason for the pausing is no longer an issue or the test fails and is marked bad.

Pausing commonly occurs due to some human interaction with the system analyzer, e.g., opening a door, which temporarily downgrades the capability(ies) of the system resource until the door is closed again. Thus, if the scheduler 50 can estimate that, for the current example, the door will be closed before the launched test needs the resource corresponding to the door, the launched test can be saved by pausing the progress of the launched test until the door actually is closed.

Finally, when neither re-scheduling nor pausing is a viable option, the scheduler 50 can mark the test as bad and the scheduler 50 is adapted to remove the bad test from the system analyzer as quickly and as safely as possible with minimal interference on other launched tests. Once a test is marked bad, real-time requirements associated with the assembled action are violated even if there are no other problems with the test.

For fast-handling scheduling the controller 30, action assembler 40, and scheduler 50 are structured and arranged to cancel or interrupt a launched test. Hence, fast-handling scheduling includes cancelling the current action being executed on the launched test, which changes the action state to “unscheduled”; scheduling the action on the higher priority test; and re-scheduling the failed action on the launched test, using an available “unscheduled” action when it becomes available. In this manner, the launched test can be salvaged by re-scheduling it from the interrupted or canceled subsystem to a corresponding, appropriate, redundant subsystem for completion of the action and subsequent disposition.

It will be apparent to those skilled in the art that modifications to and variations of the disclosed methods and apparatus are possible without departing from the inventive concepts disclosed herein, and therefore the invention should not be viewed as limited except to the full scope and spirit of the appended claims.

What we claim is:

1. A method of scheduling an operation on an object on a testing apparatus having a plurality of system resources and at least one discrete, redundant subsystem to one of the plurality of system resources, the method comprising:
scheduling in real-time a plurality of actions for execution on the plurality of system resources and on the at least one discrete, redundant subsystem, each of the plurality of actions having a start time and a completion time;
linking at least one of the plurality of system resources or a first one of said at least one discrete, redundant subsystem to another of said plurality of system resources or to a second one of said at least one discrete, redundant subsystem;
commanding at least one of said plurality of system resources and said at least one discrete, redundant subsystem to execute each of the plurality of actions for execution;
executing each of the plurality of actions;
monitoring execution of each of the plurality of actions; and
re-scheduling in real-time an action for execution on a first subsystem of said plurality of system resources on a corresponding subsystem of said at least one discrete, redundant subsystem.

2. The method as recited in claim 1 further comprising pausing the operation on the object when re-scheduling fails.

3. The method as recited in claim 2 further comprising marking the operation on the object as bad and removing said object from the testing apparatus when pausing fails.

4. The method as recited in claim 1 further comprising:
generating completion signals acknowledging that one of the plurality of system resources or one of said discrete, redundant subsystem has successfully executed an action.

5. The method as recited in claim 1 further comprising:
allocating and reserving consumable resources to be consumed during the action for execution prior to commanding said action for execution.

6. The method as recited in claim 5, the method further comprising:
making the allocated and reserved consumable resources available for use during another action for execution prior to execution of said action for execution.

7. The method as recited in claim 1 further comprising:
confirming an operating status of each of the plurality of system resources and of each of the at least one discrete, redundant subsystem.

8. The method as recited in claim 1, wherein re-scheduling includes:
re-allocating and reserving consumable resources that were allocated and reserved for consumption by the first subsystem of the plurality of subsystems for consumption during the action for execution on said corresponding subsystem.

9. A method of salvaging a launched test on a testing apparatus having a plurality of system resources of which there exists at least one discrete, redundant subsystem, salvaging being made necessary by a detected error or malfunction of a system or consumable resource, the method comprising:
scheduling in real-time a plurality of actions for execution on the plurality of system resources and on the at least one discrete, redundant subsystem, each of the plurality of actions having a start time and a completion time;
linking at least one of the plurality of system resources or a first one of said at least one discrete, redundant subsystem to another of said plurality of system resources or to a second one of said at least one discrete, redundant subsystem;
commanding at least one of said plurality of system resources and said at least one discrete, redundant subsystem to execute each of the plurality of actions for execution;
executing each of the plurality of actions;
monitoring execution of each of the plurality of actions; and
re-scheduling in real-time an action for execution on a first subsystem of said plurality of system resources on a corresponding subsystem of said at least one discrete, redundant subsystem.

10. The method as recited in claim 9 further comprising pausing the operation on the object when re-scheduling fails.

11. The method as recited in claim 9 wherein re-scheduling includes transferring the launched test from the first subsystem of said plurality of system resources to the corresponding subsystem of said at least one discrete, redundant subsystem.

12. The method as recited in claim 9 further comprising:
generating completion signals acknowledging that one of the plurality of system resources or one of said discrete, redundant subsystem has successfully executed an action.

13. The method as recited in claim 9 further comprising:
confirming an operating status of each of the plurality of system resources and of the at least one discrete, redundant subsystem.

14. The method as recited in claim 9, wherein re-scheduling includes:
re-allocating and reserving consumable resources that were allocated and reserved for consumption by the first subsystem of the plurality of system resources for consumption during the action for execution on said corresponding subsystem.

15. A scheduler for a testing apparatus having a plurality of system resources and at least one subsystem of which there exists a corresponding, discrete, redundant subsystem, the scheduler comprising:
a scheduling device that is structured and arranged to schedule, unschedule or reschedule at least one action to be executed on ones of the plurality of system resources and the corresponding, discrete, redundant subsystem,
wherein the scheduling device is structured and arranged to execute a desired function on an object by scheduling the desired function on an appropriate subsystem of the plurality of system resources and to complete the desired function on the object by rescheduling said desired function on the corresponding appropriate subsystem of the at least one discrete, redundant subsystem whenever an error or malfunction has occurred that affects completion or a time of completion of the at least one action to be executed.

16. The scheduler as recited in claim 15 further comprising an action assembly builder that is structured and arranged to link a first scheduled action of the at least one action to a second scheduled action of the at least one action, each of the first and second scheduled actions having a start time and a completion time.

17. The scheduler as recited in claim 15 further comprising a controller that is structured and arranged to generate a first set of command signals to execute a desired function on an object on an appropriate subsystem of the plurality of system resources and generating a second set of command signals to execute the desired function on a corresponding appropriate subsystem of the at least one discrete, redundant subsystem whenever execution of the desired function is affected by an error or malfunction.

18. The scheduler as recited in claim 15 further comprising data storage with which the scheduling device is electrically coupled for allocating and reserving consumable resources for the plurality of subsystems and the at least one discrete, redundant subsystem.

19. A sample analyzer, the analyzer comprising:
a plurality of system resources for performing discrete actions;
at least one discrete, redundant subsystem;
a scheduler that is structured and arranged to schedule, unschedule or reschedule a plurality of actions to be executed on the plurality of system resources;
an action assembly builder that is structured and arranged to operational connect a first scheduled action of the plurality of actions to a second scheduled action of the plurality of actions, each of the scheduled actions having a start time and a completion time; and
a controller that is structured and arranged to generate a first set of command signals to execute a desired action on an object on an appropriate subsystem of the plurality of system resources and to salvage the object by generating a second set of command signals to execute the desired action on a corresponding appropriate subsystem of said discrete, redundant subsystem whenever an error or malfunction has occurred that affects completion or a time of completion of the at least one action to be completed.

20. The analyzer as recited in claim 19, each of the plurality of system resources being adapted to perform at least one of: receive a dispatched command signal, transmit a reply to the dispatched command signal, transmit a status signal of the operability/non-operability of said subsystem, execute an action associated with the command signal, and transmit a completion signal that the action associated with the command signal has been executed.
